(19) United States
(12) Patent Application Publication
(10) Pub. No.: US 2024/0311558 A1
(43) Pub. Date: Sep. 19, 2024

(54) COMMENT SECTION ANALYSIS OF A CONTENT SHARING PLATFORM

(71) Applicant: Google LLC, Mountain View, CA (US)

(72) Inventors: Mason Henry DiMarco, San Diego, CA (US); Shuo Guo, Los Altos, CA (US); Yanan Qian, Sunnyvale, CA (US)

(21) Appl. No.: 18/182,849

(22) Filed: Mar. 13, 2023

(51) Int. Cl. G06F 40/20; G06F 16/9536

(52) U.S. Cl. CPC G06F 40/20; G06F 16/9536

(57) ABSTRACT

A media item of a content sharing platform is identified. A subset of comments in a comment section presented with the media item is identified. A comment score for each comment in the subset of comment is determined. The comment score indicates comment attributes associated with a respective comment in the subset of comments. At least one comment section score for the media item is determined based on comment scores of the subset of comments. One or more media item attributes of the media item are determined based on the at least one comment section score. The media item is associated with the one or more media item attributes. The media one or more media item attributes are indicative of whether a ranking of the media item is to be adjusted.

### TECHNICAL FIELD

Embodiments of the present disclosure relate to the field of content sharing and, more particularly, comment section analysis of a content sharing platform.

### BACKGROUND

A platform (e.g., a content sharing platform) can allow users to share video, audio, and other content. For example, a user can generate a video (e.g., using a client device) and can provide the video to the platform (e.g., via the client device) to be accessible by other users of the platform. Other users of the platform may comment on the video, respond to comments, “like” comments, or otherwise interact with comments in a comment section presented with the media item.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for comment section analysis of a content sharing platform. In an implementation, a method includes identifying a media item of a content sharing platform. The method further includes identifying a subset of comments a comment section presented with the media item. The method further includes determining a comment score for each comment in the subset of comments. The comment score indicates comment attributes associated with a respective comment in the subset of comments. The method further includes determining at least one comment section score for the media item based on comment scores of the subset of comments. The method further includes determining one or more media item attributes of the media item based on the at least one comment section score. The method further includes associating the media item with the one or more media item attributes. The one or more media item attributes are indicative of whether a ranking of the media item is to be adjusted.

In some embodiments, determining the one or more media item attributes of the media item includes determining whether the at least one comment section score satisfies one or more criteria corresponding to the one or more media item attributes. In some embodiments, the one or more media item attributes for the media item include at least one of a user level engagement attribute, a comment section satisfaction attribute, a comment section sentiment attribute, a comment section emotion attribute, a comment section content quality attribute, a comment section subscriber engagement attribute, or a comment section creator engagement attribute.

In some embodiments, determining the at least one comment section score based on the comment scores includes determining weights for the comment scores based on one or more factors, applying the weights to the comment scores of the subset of comments, and determining the comment section score based on an average of weighted comment scores of the subset of comments. In some embodiments, the one or more factors include a ratio of a number of impressions a respective comment in the subset of comments received within a time period compared to a total number of impressions the subset of comments received within the time period. In some embodiments, the one or more factors include a ratio of a number of likes a respective comment in the subset of comments received within a time period compared to a total number of likes the subset of comments received within the time period.

In some embodiments, each comment has multiple comment scores pertaining to different comment score types, and each of the at least one comment section score is determined based on comment scores of a same comment score type. In some embodiments, the subset of comments is identified based on at least one of a number of likes of each of the comments within a first time period or a number of impressions each of the comments received within a second time period.

### BRIEF DESCRIPTION OF THE DRAWINGS

Aspects and implementations of the present disclosure will be understood more fully from the detailed description given below and from the accompanying drawings of various embodiments of the present disclosure, which, however, should not be taken to limit the present disclosure to the specific embodiments, but are for explanation and understanding only.

FIG. 1 illustrates an example system architecture, in accordance with an implementation of the present disclosure.

FIG. 2 is a block diagram illustration a platform and a ranking system for the platform, in accordance with an implementation of the present disclosure.

FIG. 3 illustrates an example of a media item playback graphical user interface (GUI) with a corresponding comment section, in accordance with an implementation of the present disclosure.

FIG. 4 is a flow diagram illustrating an example method of comment section analysis of a content sharing platform, in accordance with an implementation of the disclosure.

FIG. 5 is a block diagram illustrating one implementation of a computer system, in accordance with an implementation of the disclosure.

### DETAILED DESCRIPTION

The following disclosure sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely examples. Particular implementations may vary from these example details and still be contemplated to be within the scope of the present disclosure.

On the Internet, social networks and content sharing platforms allow users to connect to and share information with each other. Many platforms (e.g., social networks, content sharing platforms, etc.) include a content sharing aspect that allows users to upload, view, and share content such as media items. Such media items may include audio clips, movie clips, TV clips, and music videos, as well as amateur content such as video blogging, short original videos, pictures, photos, other multimedia content, etc. Other users of the platform may comment on the content, discover new content, locate updates, share the content, and otherwise interact with the content. The content may include content from professional content creators, e.g., movie clips, TV clips, and music videos, as well as content from amateur content creators, e.g., video blogging and short original videos. Users may use client devices (such as smart phones, cellular phones, laptop computers, desktop computers, netbooks, tablet computers) to use, play, and/or consume content (e.g., watch digital videos, and/or listen to digital music).

A content sharing platform can include one or more channels that may be viewable over the Internet. A channel is a mechanism for providing certain media items and/or for providing access to media items to subscribers. Media items for the channel can be selected by a user, uploaded by a user, selected by a content provider, or selected by a broadcaster. Subscribers are users that subscribe to one or more channels. Upon subscribing, the user can view his or her subscriptions from the homepage of the content hosting site or from a user interface by clicking on a “Subscriptions” link/button. With many channels and even more media items associated with a content sharing platforms or viewable over the Internet, it may be difficult for a user to find new media items to consume and/or to decide which media items to consume.

Some content sharing platforms may identify media items that may be of interest to a user or group of users, and present an indicator (e.g., interface component, electronic message, recommendation feed, etc.) of media items that may appeal to a user. For example, an indicator may be presented as a thumbnail of a media item. Responsive to interaction by the user (e.g., click), a larger version of the media item maybe presented for playback. Some content sharing platforms may determine which media items can be of interest to the user based on popularity of media items on a respective content sharing platform and/or other platforms and systems. Popularity of a media item may be defined based on one or more factors including a number of comments in a comment section presented with the media item. As such, creators of the media items often encourage their subscribers to generate (e.g., post) a large number (e.g., 100 or more) of comments in the comment section to cause the content sharing platform to identify the media item as popular. Users typically prefer to watch or listen to content without interruptions or having to decide what to watch next, and therefore content sharing platforms typically present popular media items that users are likely to watch. However, predicting that a media item can be of interest to a user based on a number of comments in the comment section and without considering other factors related to such comments (e.g., the quality of such comments) may not reflect the user's dynamic interests. Presenting a media item that the user may ultimately be disinterested in needlessly consumes computing resources, which can decrease an overall efficiency and increase an overall latency for the platform.

Aspects and implementations of the present disclosure address the above and other deficiencies by identifying media items that may of interest to a user based on comment section analysis of a content sharing platform. A content sharing platform may allow users to consume, upload, share, search for, and/or comment on media items. A content sharing platform may present (e.g., via a graphical user interface (GUI)) a media item to a user at a client device. In some instances, the content sharing platform can present a comment section with the media item. Users of content sharing platform can interact with the comment section. For example a user can add a comment to the comment section, “like” (approve) or “dislike” (disapprove) a comment in the comment section, reply to a comment in the comment section, etc.

A platform can identify comments within a comment section of a media item to determine a comment score associated with each comment. For example, the platform can identify a predefined number (e.g., ten) of the “top comments” within the comment section. In some embodiments, the “top comments” can be the comments within the comment section with the greatest number of impressions received over a certain interval (e.g., over a 24 hour interval). The number of impressions received may correspond to the number of users that have been presented a comment for a certain amount of time (e.g., two seconds).

As indicated above, the platform can identify a predefined number of comments of a comment section based on a number of impressions. The platform can then determine comment scores for the identified comments. The comment scores can indicate comment attributes associated with the identified comments. For example, the platform can determine comment scores using at least one of the level (e.g., age range, education level, etc.) of users that authored the comments, a comment section satisfaction attribute, comment sentiment analysis, comment emotion indicators, text quality scores, subscriber engagement scores, or creator engagement scores, as described in detail below.

The platform can determine a comment section score based on the comment scores. In some embodiments, the comment section score can be an average of the weighted comment scores. For example, the platform can weight the identified comment scores based on a number of impressions a comment received compared to a total number of impressions the identified comments (e.g., all identified comments) received. The platform can then average or aggregate the weighted scores of the comments in the comment section to obtain a comment section score. Accordingly, the more impressions a comment receives, the more weight the corresponding comment score will have in the comment section score computation.

In some embodiments, one or more comment section scores can be calculated for a media item, where the one or more comment section scores are used to determine one or more media item attributes of the media item. The media item attributes for the media item can include, for example, a user level engagement attribute, a comment section satisfaction attribute, a comment section sentiment attribute, a comment section emotion attribute, a comment section content quality attribute, a comment section subscriber engagement attribute, or a comment section creator engagement attribute, or any combination of the above.

Using a user level engagement attribute as an example, this attribute can be an engagement indicator for viewers associated with a particular level (e.g., an age range or an education level). That is, the user level engagement attribute can provide an indication of certain groups of users (e.g., “young adult” users between the age of 21 and 29, users with a high school diploma, users with a college degree, users with a postgraduate degree, etc.) that are likely to engage with (e.g., “like”, view, comment on, share, etc.) the media item. As such, a comment section score pertaining to a user level engagement attribute may provide, for example, an indication that the weighted average age range of the authors of the identified comments is between the age of 21 and 29. Accordingly, the platform can determine that the media item should be associated with an attribute indicating viewer engagement of young adults. In some embodiments, the platform can make such a determination if the comment section score pertaining to the user level engagement attribute satisfies threshold criteria for the user level engagement attribute. For example, the threshold criteria for the young adult user level engagement attribute may require that the comment section score resulting from the weighted average age range of the authors of the identified comments be above the age of 20 and below the age of 30. If the threshold criteria are satisfied, the platform associates the media item with the attribute indicating viewer engagement of young adults, and this attribute is then used to determine whether the ranking of the media item should be adjusted for a particular user. For example, based on this attribute, the platform may decide to boost (e.g., increase) the ranking of the media item for young adult users, and decrease or keep unchanged the ranking of the media item for users associated with other levels (e.g., other age groups or other education levels).

It can be appreciated that a comment section score pertaining to a user level engagement attribute is used as example comment section score by way of illustration, and not by way of limitation. Other or additional types of comment section scores may be utilized with respect to the disclosed technique, as described in detail below.

Performing comment section analysis to accurately identify media items relevant to users improves an overall user experience with the content sharing platform, and increases the number of live-stream media items and other media items consumed by the users of the content sharing platform. In addition, aspects and implementations of the present disclosure result in more efficient use of processing resources by presenting media items relevant to users rather than media items that the user is disinterested in, thereby avoiding consumption of computing resources needed to support searches that users would otherwise have to initiate to find media items relevant to their interests.

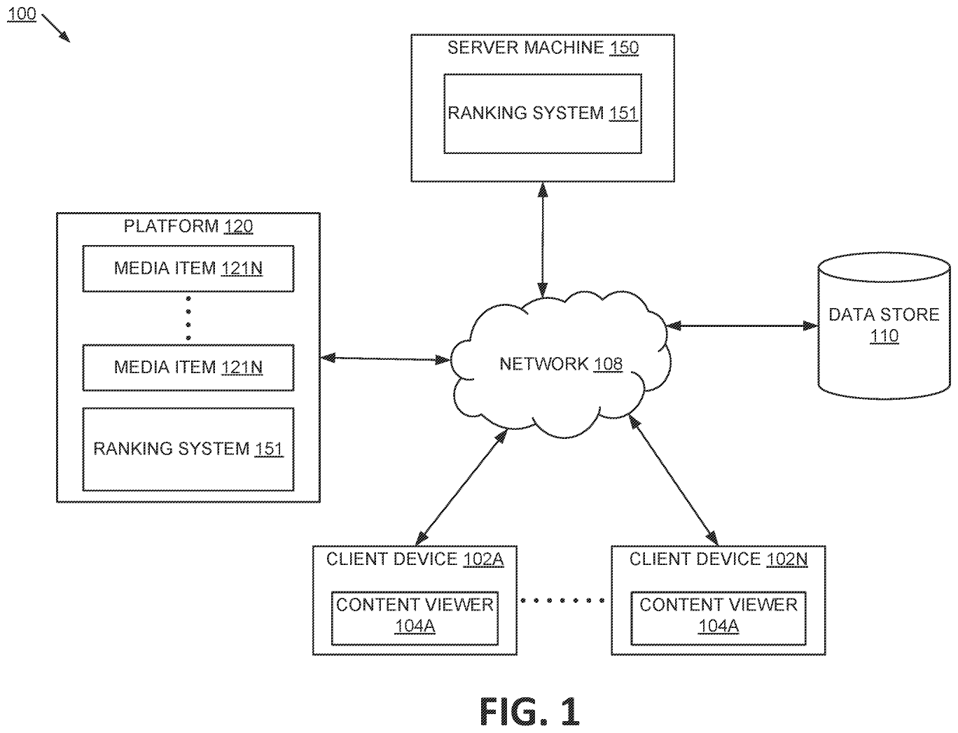

FIG. 1 illustrates an example system architecture 100, in accordance with one implementation of the present disclosure. The system architecture 100 (also referred to as “system” herein) includes a platform 120 (e.g., a content sharing platform 120), a server machine 150, a data store 110, and client devices 102A through 102N (generally referred to as “client devices 102” herein) connected to a network 108. Network 108 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, platform 120 can be a content sharing platform that allows users to consume, upload, share, search for, approve of (“like”), dislike, and/or comment on media items 121A through 112N (referred to generally as “media items 121” herein). Platform 120 can include a website (e.g., a webpage) or application back-end software used to provide a user with access to media items 121 (e.g., via client device 102). A media item 121 can be consumed via the Internet or via a mobile device application, such as a content viewer 104 of client device 102. In some embodiments, a media item 121 can correspond to a media file (e.g., a video file, and audio file, etc.). A media item 121 can be requested for presentation to the user by the user of the platform 120. As used herein, “media,” media item,” “online media item,” “digital media,” “digital media item,” “content,” and “media item” can include an electronic file that can be executed or loaded using software, firmware or hardware configured to present the digital media item to an entity. In one implementation, platform 120 can store the media items 121 using data store 110. In another implementation, platform 120 can store media item 121 or fingerprints as electronic files in one or more formats using data store 110. Platform 120 can provide media item 121 to a user associated with client device 102 by allowing access to media item 121 (e.g., via a content sharing platform application), transmitting the media item 121 to the client device 102, and/or presenting or permitting presentation of the media item 121 via client device 102.

In some embodiments, media items 121 can be video items. A video item is a set of sequential video frames (e.g., image frames) representing a scene in motion. For example, a series of sequential video frames may be captured continuously or later reconstructed to produce animation. Video items may be presented in various formats including, but not limited to, analog, digital, two-dimensional and three-dimensional video. Further, video items may include movies, video clips or any set of animated images to be displayed in sequence. In addition, a video item may be stored as a video file that includes a video component and an audio component. The video component may refer to video data in a video coding format or image coding format (e.g., H.264 (MPEG-4 AVC), H.264 MPEG-4 Part 2, Graphic Interchange Format (GIF), WebP, etc.). The audio component may refer to audio data in an audio coding format (e.g., advanced audio coding (AAC), MP3, etc.). It may be noted GIF may be saved as an image file (e.g., .gif file) or saved as a series of images into an animated GIF (e.g., GIF89a format). It may be noted that H.264 may be a video coding format that is block-oriented motion-compensation-based video compression standard for recording, compression, or distribution of video content, for example.

Platform 120 can include multiple channels (e.g., channels A through Z). A channel can include one or more media items 121 available from a common source or media items 121 having a common topic, theme, or substance. Media item 121 can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” may also be referred to as “following,” “friending,” and so on. Once a user subscribes to a channel, the user can be presented with information from the channel's activity feed. If a user subscribes to multiple channels, the activity feed for each channel to which the user is subscribed can be combined into a combined activity feed. Information from the combined activity feed can be presented to the user. A user that subscribes to an owner's channel can be referred to as a “subscriber” of the channel or the owner.

In some embodiments, system 100 can include one or more third party platforms (not shown). In some embodiments, a third-party platform can provide other services associated media items 121. For example, a third-party platform can include an advertisement platform that can provide video and/or audio advertisements. In another example, a third-party platform can be a video streaming service provider that produces a media streaming service via a communication application for users to play videos, TV shows, video clips, audio, audio clips, and movies, on client devices 102 via the third party platform.

In some embodiments, data store 110 is a persistent storage that is capable of storing data as well as data structures to tag, organize, and index the data. A data item can include audio data and/or video data, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 108. Data store 110 may include a media cache that stores copies of media items that are received from the platform 120. In one example, each of the media items 121 may be a file that is downloaded from platform 120 and may be stored locally in media cache. In another example, each media item 121 may be streamed from platform 120 and may be stored as an ephemeral copy in memory of server machine 150.

Client devices 102 may include computing devices such as personal computers (PCs), laptops, mobile phones, smart phones, tablet computers, netbook computers, network-connected televisions, etc. In some examples, client devices 102 may also be referred to as “client devices.” Client devices 102 can include one or more computing devices such as personal computers (PCs), laptops, mobile phones, smart phones, tablet computers, netbook computers, network-connected televisions, etc. In some implementations, client device 102 can also be referred to as a “client device.” Client device 102 can include a content viewer. In some implementations, a content viewer can be an application that provides a graphical user interface (GUI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded content viewer (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital video items, digital images, electronic books, etc.). According to aspects of the disclosure, the content viewer can be a content sharing platform application for users to record, edit, and/or upload content for sharing on platform 120. As such, the content viewers can be provided to the client device 102 by platform 120. For example, the content viewers may be embedded content viewers that are embedded in web pages provided by the platform 120.

In one implementation, the content sharing platform 120 or server machines 130-150 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to media items and/or provide the media items to the user. For example, the content sharing platform 120 may allow a user to consume, upload, search for, approve of (“like”), disapprove of (“dislike”), or comment on media items. The content sharing platform 120 may also include a website (e.g., a webpage) or application back-end software that may be used to provide a user with access to the media items.

Ranking system 151 of platform 120 may rank and/or adjust rankings of media items for a user or group of users in view of comment section scores of the respective media items. Based on ranking, a media item can be recommended to a user using, for example, an interface component, an electronic message, a recommendation feed, etc. For example, a recommendation may be presented as a thumbnail of a media item. Responsive to interaction by the user (e.g., click), a larger version of the media item maybe presented for playback. In implementations, a recommendation may be made using data from a variety of sources including a user's favorite media items, recently added playlist media items, recently watched media items, media item ratings, information from a cookie, user history, and other sources. In one implementation, a recommendation may be based on comment section analysis, as described in further detail below. It may be noted that a recommendation may be for a media item 121, a channel, a playlist, among others. In some embodiments, a recommendation may be for one or more video items on content sharing platform 120.

In some implementations, platform 120 and/or server machine 150 may operate on one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable a user to access media items provided to platform 120 by other users. In some implementations, the functions of platform 120, and/or server machine 150 can be provided by more than one machine. For example, the functions of ranking system 151 can be provide by two or more separate sever machine. Content sharing platform 120, and/or server machine 150 can also include a website (e.g., a webpage) or application back-end software that can be used to enable a user to access media items.

In general, functions described in implementations as being performed by platform 120 can also be performed on the client devices 102 in other implementations, if appropriate. In addition, the functionality attributed to a particular component can be performed by different or multiple components operating together. Content sharing platform 120 can also be accessed as a service provided to other systems or devices through appropriate application programming interfaces, and thus is not limited to use in websites.

It should be noted that although some embodiments of the present disclosure are directed to a content sharing platform, embodiments of this disclosure can be applied to other types of platforms. For example, embodiments of the present disclosure can be applied to a content archive platform, a content storage platform, etc.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline, such as a topic channel, of the platform 120.

In situations in which the systems discussed here collect personal information about users, or can make use of personal information, the users can be provided with an opportunity to control whether platform 120 collects user information (e.g., information about a user's social network, social actions or activities, profession, a user's preferences, or a user's current location), or to control whether and/or how to receive content from the content server that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the platform 120.

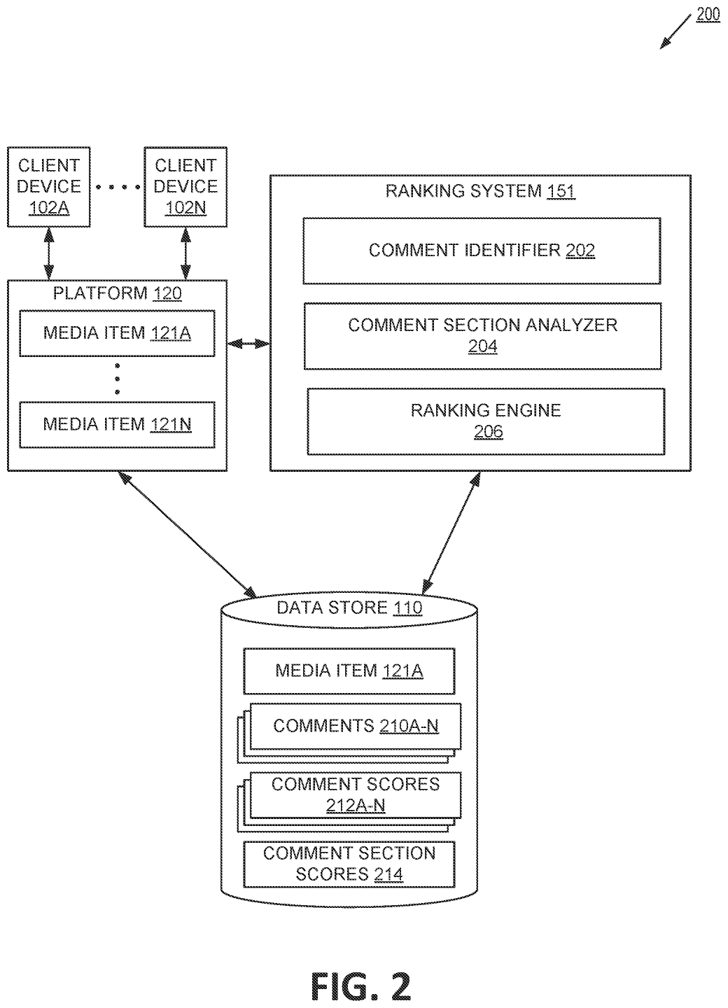

FIG. 2 is a block diagram illustrating a platform 120 and a ranking system 151 for the platform, in accordance with an implementation of the disclosure. As described with respect to FIG. 1, platform 120 can enable a user to provide a media item 121 (e.g., a video item) for access by other users of platform 120. In some embodiments, a client device 102 can transmit a request (e.g., via network 108) to platform 120 to make a media item 121 accessible to other users, where the request identifies the media item 121. In response to receiving the request with media item 121, platform 120 can provide the media item 121 (or an indication of the media item 121) to ranking system 151. In other or similar embodiments, platform 120 can store the media item 121 at data store 110 and ranking system 151 can identify the requested media item 121 from data store 110. In some embodiments, one or more portions of data store can be included at or can otherwise correspond to another memory of system 100.

As illustrated in FIG. 2, ranking system 151 can include comment identifier 202, comment section analyzer 204, and ranking engine 206. In some embodiments, one or more of comment identifier 202, comment section analyzer 204, and/or ranking engine 206 can reside at another computing system of system 100 (e.g., at server machine 150) and can be accessible to ranking system 151 (e.g., via network 108, via a bus, etc.).

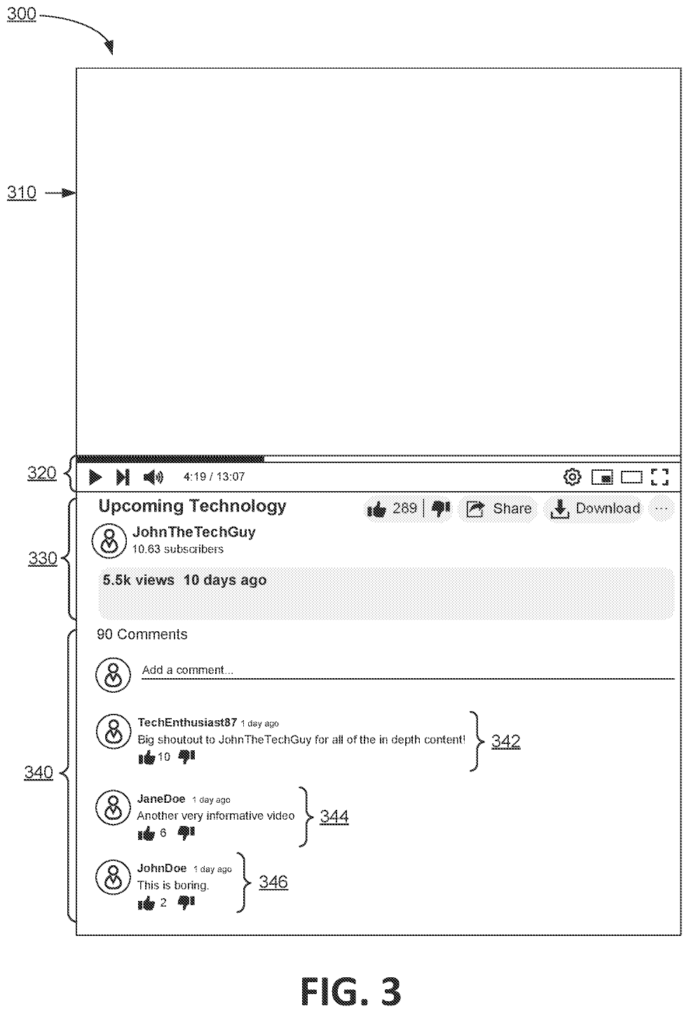

Comment identifier 202 can identify one or more comments associated with media item 121. In some embodiments, the one or more comments can be included within a comment section corresponding to media item 121 of platform 120. Platform 120 can provide a UI to present media item 121 to a user via a media player. In some embodiments, a portion of the provided UI can include a comment section for users of platform 120 to interact with, as described below with respect to FIG. 3.

FIG. 3 illustrates an example of a media item playback graphical user interface (GUI) 300 with a corresponding comment section 340, in accordance with implementations of the present disclosure. The media item playback GUI 300 may be provided to a user viewing a media item (e.g., media item 121) at a client device (e.g., client device 102). The media item playback GUI 300 includes a media player 310 displaying the media item and a media item information section 330. The media player 310 may include a playback control bar 320 providing a timeline of the media item indicating where a user is during playback of the media item and controls to control playback of the media item (e.g., stop, pause, volume, etc.).

Media item information section 330 can detail identifying information of a media item currently presented in media player 310. Media item information section 330 may include, but is not limited to, information such as a title of the media item, content owner of the media item, posting date of the media item, duration of the media item, number of views of the media item, number of “likes” (e.g., thumbs up) of the media item, number of “dislikes” (e.g., thumbs down) of the media item, and so on.

In some embodiments, media item playback GUI 300 can include a comment section 340. Comment section 340 can be part of media player 310. The comment section 340 is located below media item information section 330, as illustrated with respect to FIG. 3. Comment section can be a portion of media item playback GUI 300 for users of a content sharing platform to interact with other users viewing a corresponding media item and a creator of the media item. For example, a user may post a comment to a comment section 340, view other comments displayed within comment section 340, and interact with (e.g., like, dislike, respond to, etc.) comments posted by other users of the content sharing platform.

As illustrated with respect to FIG. 3, comment section 340 includes a first comment 342 added by a first user “TechEnthusiast87”, a second comment 344 added by a second user “JaneDoe”, and a third comment 346 added by a third user “JohnDoe” 346. In some embodiments, comments can be presented within comment section 340 in an order according to a quantity of “likes” received. For example, the first comment 342 is presented at the top of comment section 340 as the first comment 342 received ten “likes.” The second comment 344 is presented below the first comment 342 as the second comment 344 received six “likes.” The third comment 346 is presented below the second comment 344 as the third comment 346 received two “likes.”

In some embodiments, comments can be presented within comment section 340 in an order according to a quantity of impressions received. The quantity of impressions corresponds to the number of users that have been presented (e.g., via media item playback GUI 300) a comment for a predefined period of time (e.g., 2 seconds), as described above. For example, comment 342 can generate an impression responsive to a user being presented (e.g., at a client device) comment 342 for 1.5 seconds. In some embodiments, comments can be presented within comment section 340 in an order according to the quantity of impression received over a predefined time period. For example, comment 342 may receive 1,000 impressions over a 24-hour period (e.g., a last 24-hour period) and, therefore, can be presented at the top of comment section 340. Comment 344 may receive 500 impressions over the last 24 hours and, therefore, can be presented below comment 342. Comment 346 may receive 250 impressions over the last 24 hours and, therefore, can be presented below comment 344.

In some embodiments, comment section 340 can include a navigable (e.g., scrollable) list of comments associated with a media item and can include one or more control elements, e.g., a button to hide comments associated with comment section 340, a scrollable UI element to view additional comments associated with comment section 340, etc. Locations and configurations of comment section 340 other than those described with respect to media item playback GUI 300 may also be utilized in implementations of the present disclosure.

Returning to FIG. 2, comment identifier 202 can identify a subset of comments 210A-N (referred to generally as “comments 210” herein) of a comment section (e.g., comment section 340) corresponding to a media item 121. In some embodiments, the subset of comments can include a predefined number of comments 210 (e.g., a number defined by a developer and/or operator associated with platform 120). For example, comment identifier 202 can identity ten comments 210 in the comment section.

In some embodiments, comment identifier 202 can identify comments 210 based on a number of likes. For example, comment identifier 202 can identify ten comments 210 from the comment section with the greatest number of likes. In some embodiments, comment identifier 202 can identify comments 210 based on a number of likes received within a first time period. For example, comment identifier 202 can identify ten comments 210 from the comment section with the greatest number of likes received within a 24-hour period (e.g., the last 24 hours from the beginning of the comment identification operation).

In some embodiments, comment identifier 202 can identify comments based on a number of impressions. For example, comment identifier 202 can identify ten comments 210 in the comment section with the greatest number of impressions. In some embodiments, comment identifier 202 can identify comments 210 based on a number of impressions received within a second time period which may be the same as or different from the first time period. For example, comment identifier 202 can identify ten comments 210 from the comment section with the greatest number of impressions received within a 24-hour period (e.g., the last 24 hours from the beginning of the comment identification operation).

Comment section analyzer 204 can obtain comments 210 from comment identifier 202 and determine comment scores 212A through 212N (referred to as “comment scores 212” herein). For example, comment section analyzer 204 can obtain comments 210A through 210J (e.g., ten comments of a comment section with the greatest number of impressions) and determine comment scores 212A through 212J for the respective comments 210A through 210J.

In some embodiments, comment section analyzer 204 can determine one or more comment scores 212 for each of comments 210A through 210J. One comment score can be a comment satisfaction score. The comment satisfaction score can be determined by a model trained to predict how “satisfying” a comment would be for a user of content sharing platform 120. In some embodiments, the model can be trained based on training data including previous comments and user feedback. In some embodiments, a survey is presented to users to provide feedback, e.g., to indicate how satisfying a given comment is to the users. Each user can provide a response to the survey by engaging with a satisfaction ranking GUI element provided by platform 120 via a GUI of a client device. For example, the satisfaction ranking GUI element can include five stars for a user to engage with. The user can engage one of the five stars to indicate a low comment satisfaction ranking. The user can engage all of the five stars to indicate a high comment satisfaction ranking.

In some embodiments, one or more comment scores 212 can include a comment sentiment score determined based on comment sentiment analysis. Comment sentiment analysis can refer to the process of analyzing language (e.g., phrases, words, etc.) expressed in a piece of text to determine the author's attitude (e.g., positive, negative, neutral). In some embodiments, comment sentiment analysis can be performed using a machine learning model. The machine learning model can be trained on historical data (e.g., previous comments and user provided sentiments for those comments) to predict a sentiment of a word, phrase, or text. The sentiment is an indicator of how “positive” or how “negative” the text is. For example, the machine learning model can determine that comment 344 of FIG. 3, which states “Another very informative video,” is positive comment. In another example, the machine learning model can determine that comment 346 of FIG. 3, which states “This is boring,” is a negative comment. Accordingly, the output of the machine learning model can indicate a comment sentiment score for a corresponding comment 210.

In some embodiments, one or more comment scores 212 can include a user level score of users that authored (e.g., posted) comments 210. A user of a content sharing platform 120 can create a user profile and specify certain information in the user profile (e.g., name, email address, occupation, age range, education level, etc.). User profiles can further include historical data associated with a respective user. In some implementations, historical data may include data provided by the user (e.g., data provided when a user creates a user profile for content sharing platform 120, data provided by a user in response to questions prompted by content sharing platform 120, etc.). In other or similar implementations, historical data may include data collected as a result of the user interacting with content sharing platform 120. Comment section analyzer 204 can use historical data of a respective user to determine a level of the respective user. Comment section analyzer 204 can determine a user level score indicating the level of the user that authored the corresponding comment 210.

In some embodiments, one or more comment scores 212 can include a comment emotion score. Comment section analyzer 204 can determine comment emotion scores based on a comment emotion analysis. Comment emotion analysis can refer to a process of analyzing language and symbols expressed in a piece of text (e.g., a comment 210) to determine an associated emotion (e.g., happy, sad, funny, etc.). For example, comment section analyzer 204 can identify an emoji within a comment 210 depicting a person laughing, and associate a “funny” emotion with the comment 210 based on the presence of the emoji. In some embodiments, comment section analyzer 204 can perform comment emotion analysis by generating a comment sentiment score for each comment 210 using a machine learning model. The machine learning model can be trained on historical data (e.g., previous comments and user provided emotion indicators for those comments) to predict an emotion associated with a word, phrase, or text. Accordingly, the output of the machine learning model can indicate a comment emotion score for a corresponding comment 210.

In some embodiments, one or more comment scores 212 can include a text quality score. Comment section analyzer 204 may determine a text quality score by performing text quality analysis of comments 210. Text quality analysis can refer to the process of analyzing language expressed in a text (e.g., comment 210) to determine a quality level of the text. In some embodiments, comment section analyzer 204 can perform quality analysis by generating a comment quality score for each comment 210 using a machine learning model. The machine learning model can be trained on historical data (e.g., previous comments and user provided characteristics of content of those comments) to detect text that expresses hate, harassment, bullying, self-harm, etc. Accordingly, the output of the machine learning model can indicate a text quality score for a corresponding comment 210.

In some embodiments, one or more comment scores 212 can include a subscriber engagement score. The subscriber engagement score can be determined based on a rate of comments authored by subscribers of the media item creator's channel relative to a total number of comments in the comment section of the media item. As indicated above, a subscriber is a user that subscribes to a channel of a creator of the media item. In one example, comment identifier 202 may identify ten comments (e.g., comments 210A through 210J). If three (e.g., comment 210A, comment 210B, and comment 210C) of the identified ten comments are authored by subscribers, the subscriber engagement score would be 30% (i.e., 3/10). Accordingly, the subscribed engagement score may provide an indication of a proportion of users interacting with the comment section that are subscribers.

In some embodiments, one or more comment scores 212 can include a creator engagement score. Comment section analyzer 204 can determine the creator engagement score based on a rate a creator of media item 121 interacts with a comment section of media item 121 by “liking” or replying to comments relative a number of comments in the comment section. For example, the creator engagement score can be determined based on a rate of creator “likes” and/or creator replies associated with comments 210 to the number of comments 210 in the comment section of media item 121. In another example, a rate of creator “likes” and creator replies associated with comments 210 to the number of comments 210 of media item 121 can be calculated based on a number of comments 210 the creator has “liked” and/or the number of comments 210 the creator has replied to, compared to the number of views media item 121 has received. For example, if the creator “liked” 20 comments and the media item 121 received 1000 views, the creator engagement score would be 0.0002% (i.e., 20/1000).

Comment section analyzer 204 can determine one or more comment section scores for a media item. In some embodiments, comment section analyzer 204 produces only one comment score for each comment in the comment section of the media item. For example, comment section analyzer 204 may only produce one type of comment scores (e.g., only a user level score or a text quality score) for comments in the comment section of the media item, and a single comment section score is calculated based on these comment scores using weights associated with different comments. Alternatively, comment section analyzer 204 may produce multiple types of comment scores (e.g., a user level score and a text quality score) for individual comments in the comment section of the media item, and these multiple types of comment scores can be combined to produce a single comment section score based on these comment scores using weights associated with different comments and/or weights associated with different types of comment scores.

In some embodiments, comment section analyzer 204 produces multiple comment section scores for a comment section of the media item, where each comment section score pertains to the same type of comment scores. Examples of comment section score types may include a user level engagement comment section score, a comment section satisfaction score, a comment section sentiment score, a comment section emotion score, a comment section content quality score, a comment section subscriber engagement score, or a comment section creator engagement score, or any combination of the above.

In some embodiments, for each comment section score type, comment section analyzer 204 can determine a comment section score by determining a weighted average or aggregation of comment scores 212 (e.g., comment scores of the same type). Comment section analyzer 204 can determine weights for the comment scores 212 based on one or more factors. In some embodiments, the one or more factors can include a number of impressions a respective comment in a set comments received within a first time period (e.g., within the previous 24 hours) compared to a total number of impressions the subset of comments 210 received within the first time period. In some embodiments, the one or more factors can include a number of “likes” a respective comment in a set comments received within a second time period (e.g., within the previous 24 hours) compared to a total number of “likes” the subset of comments 210 received within the second time period. The second time period may be the same as or different from the first time period. Comment section analyzer 204 can apply the weights to the comment scores of the respective comments 210 and calculate comment section score 214 by aggregating or averaging the weighted comments 210. For example, comment section analyzer 204 can calculate comment section score 214 using equation (1) below, where (n+1) is the number of comments 210 (e.g., i=0 corresponds to the comment 210A, i=1 corresponds to comment 210B, i=2 corresponds to comment 210C, etc.):

$$comment section score = {\sum }_{i = 0}^{n} \frac{impressions ( n ) * comment score ( n )}{total impressions} \qquad ( 1 )$$

Accordingly, comment section score 214 can be a weighted aggregation or weighted average of comment scores 212 (e.g., comment scores of the same type). Comment section analyzer 204 can use comment section score 214 to determine media item attributes of the media item. The media item attributes for the media item can include, for example, a user level engagement attribute, a comment section satisfaction attribute, a comment section sentiment attribute, a comment section emotion attribute, a comment section content quality attribute, a comment section subscriber engagement attribute, or a comment section creator engagement attribute, or any combination of the above.

In one example, comment section analyzer 204 can determine comment scores 212 based on an engagement indicator for viewers associated with a particular level (e.g., an age range or an education level). That is, the user level engagement indicator can specify different groups of users (e.g., “young adult” users between the age of 21 and 29, users with a high school diploma, users with a college degree, users with a postgraduate degree, etc.) that are likely to engage with (e.g., “like”, view, comment on, share, etc.) the media item. As such, a comment section score of the user level type may provide, for example, an indication that the weighted average age range of the authors of comments 210 is between the age of 21 and 29. Accordingly, comment section analyzer 204 can determine that the media item should be associated with an attribute indicating viewer engagement of young adults. In some embodiments, comment section analyzer 204 can make such a determination if the comment section score pertaining to the user level engagement attribute satisfies threshold criteria for the user level engagement attribute. For example, the threshold criteria for the young adult user level engagement attribute may require that the comment section score resulting from the weighted average age range of the authors of the identified comments be above the age of 20 and below the age of 30. If the threshold criteria are satisfied, comment section analyzer 204 associates the media item with the attribute indicating viewer engagement of young adults. Ranking engine 206 can then use this attribute to determine whether the ranking of the media item should be adjusted for a particular user or for a particular group of user. For example, based on this attribute, ranking engine 206 may boost (e.g., increase) the ranking of the media item for young adult users, and decrease or keep unchanged the ranking of the media item for users associated with different levels. Based on the ranking, the platform can present the media item (e.g., as a recommendation) to young adult users, and not present the media item to users associated with different levels.

In another example, comment section analyzer 204 can determine comment scores 212 based on comment section content quality. A comment section score 214 of the comment section quality type may provide, for example, an indication that the weighted average quality level of comments 210 is a low quality level (e.g., include text that expresses hate, harassment, bullying, self-harm, etc.), as described above. Accordingly, comment section analyzer 204 can determine that the media item should be associated with an attribute indicating low content quality of the comment section. In some embodiments, comment section analyzer 204 can make such a determination if the comment section score 214 of content quality type satisfies a corresponding threshold criterion. For example, the threshold criterion for the content quality type may require that the comment section score resulting from the weighted average text quality score of comments 210 indicate that more than 10% of comments 210 include low quality text. If the threshold criterion is satisfied, comment section analyzer 204 can associated the media item with a comment section content quality attribute that indicates a low quality level. Ranking engine 206 can then use this attribute to determine whether the ranking of the media item should be adjusted for a particular user or for all users of the platform. For example, based on this attribute, ranking engine 206 may decrease the ranking of the media item for all users of the platform. In some embodiments, based on the ranking, the platform may not present the media item to all users of the platform or to users at a particular level(s) (e.g., young adult users).

In another example, comment section analyzer 204 can determine comment scores 212 based on a comment section emotion indicator (e.g., humorous, sad, happy, etc.) that is associated with the media item. A comment section score 214 of the emotion type can provide, for example, an indication that users of the platform perceive the media item as humorous. Accordingly, comment section analyzer 204 can determine that the media item should be associated with a comment section emotion attribute indicating that the media item is humorous. In some embodiments, comment section analyzer 204 can make such a determination if the comment section score pertaining to the comment section emotion attribute satisfies threshold criteria for the comment section emotion attribute. For example, the threshold criteria for the comment section emotion attribute may require that the comment section score resulting from the weighted average emotion indicators of comments 210 indicates that more than 50% of comments 210 include an emotion indicator associated with humor. If the threshold criterion is satisfied, comment section analyzer 204 can associate the media item with a media item attribute that indicates user perception of the media item as humorous. Ranking engine 206 can then use this media item attribute to determine whether the ranking of the media item should be adjusted for a particular user or a particular group of users. For example, based on this attribute, ranking engine 206 may boost (e.g., increase) the ranking of the media item for users that have historically interacted positively (e.g., “liked,” viewed, commented on) other media items identified as humorous. In some embodiments, based on this attribute, the platform can present the media item as a recommendation to such users. For example, the media item can be presented to one or more users as a part of a comedy playlist on a homepage of the content sharing platform. The comedy playlist may include multiple media items (e.g., 121A, 121B, 121C, etc.) that the content sharing platform has determined to be associated with comedy. The comedy playlist may be presented as thumbnails of media item 121A, media 121B, and media item 121C in a navigable portion of the homepage of the content sharing platform.

In some embodiments, ranking engine 206 can use multiple different attributes to determine whether a ranking of the media item should be adjusted for a particular user or group of users. For example, comment section analyzer 204 may associate the media item with a media item attribute indicating viewer engagement of young adults, as described above. Based on the viewer engagement attribute, ranking engine 206 may determine to boost (e.g., increase) the ranking of the media item for young adult users. However, comment section analyzer 204 may additionally associate the media item with a comment section content quality attribute that indicates a low quality level. The low quality level may indicate, for example, that hate speech is present in one or more of the comments 210. Based on the comment section content quality attribute, comment section analyzer 204 may decrease the ranking of the media item for young adult users, and decrease or keep unchanged the ranking of the media item for users associated with different levels. Accordingly, the ranking decrease determined as a result of the comment section quality attribute may offset or negate the ranking increase for young adult users determined as a result of the media item attribute indication viewer engagement of young adults.

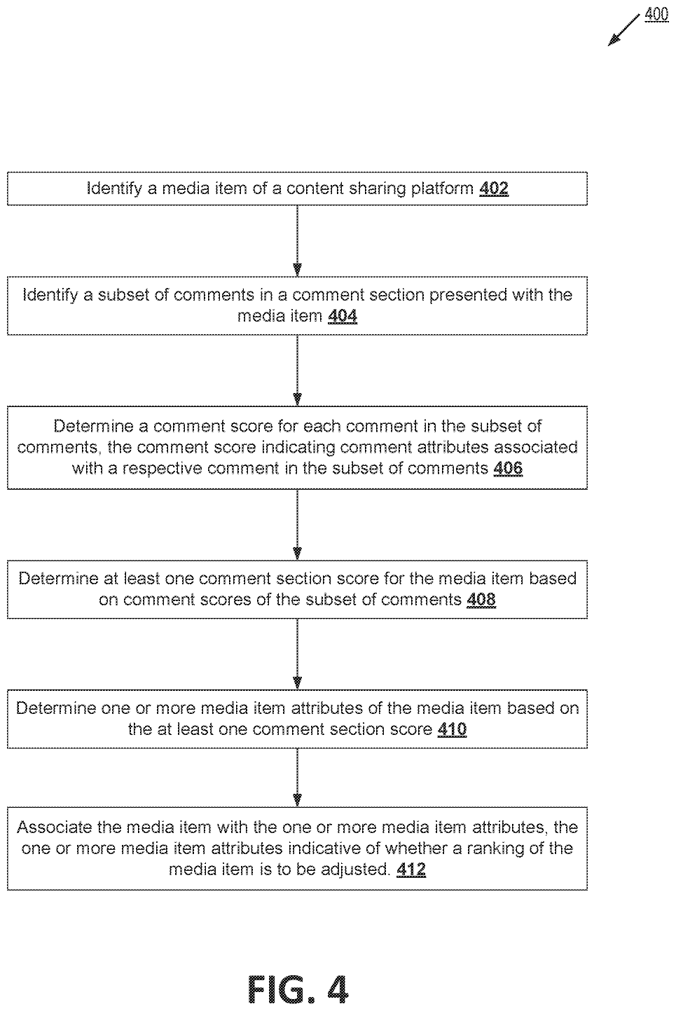

FIG. 4 is a flow diagram illustrating an example method of comment section analysis of a content sharing platform, in accordance with an implementation of the disclosure. Method 400 may be performed by processing logic that may include hardware (circuitry, dedicated logic, etc.), software (e.g., instructions run on a processing device), or a combination thereof. In one implementation, some or all the operations of methods 400 may be performed by one or more components of system 100 of FIG. 1. In at least one embodiment, some or all of the operations of method 400 can be performed by a server device, as described above.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

At block 402, a processing logic may identify a media item of a content sharing platform. The media item may be a video that was previously uploaded by a user of a content sharing platform and was viewed and/or otherwise interacted with (e.g., commented on) by other users of the content sharing platform.

At block 404, the processing logic may identify a subset of comments in a comment section presented with the media item. In some embodiments, the subset of comments is identified based on at least one of a number of likes of each of the comments within a first time period or a number of impression each of the comments received within a second time period.

At block 406, the processing logic may determine a comment score for each comment in the subset of comments, the comment score indicating comment attributes associated with a respective comment in the subset of comments.

At block 408, the processing logic may determine at least one comment section score for the media item based on comment scores of the subset of comments. In some embodiments, the processing logic may determine weights for the comment scores based on one or more factors. The processing logic may further apply the weights to the comment scores of the subset of comments. The processing logic may further determine the comment section score based on an average of weighted comment scores of the subset of comments. In some embodiments, the one or more factors may include a ratio of a number of impression a respective comment in the subset of comments received within a time period compared to a total number of impressions the subset of comment received within the time period. In some embodiments, the one or more factors may include a ratio of a number of likes a respective comment in the subset of comments received within a time period compared to a total number of impressions the subset of comment received within the time period.

At block 410, the processing logic may determine one or more media item attributes of the media item based on the at least one comment section score. In some embodiments, to determine the one or more media item attributes of the media item, the processing device may determine whether the at least one comment section score satisfies one or more criteria corresponding to the one or more media item attributes. In some embodiments, the one or more media item attributes for the media item may include at least one of a user level engagement attribute, a comment section satisfaction attribute, a comment section sentiment attribute, a comment section emotion attribute, a comment section content quality attribute, a comment section subscriber engagement attribute, or a comment section creator engagement attribute. In some embodiments, each comment may have multiple comment scores of different types and each comment section score is determined based on comment scores of the same type.

At block 412, the processing device may associate the media item with one or more media item attributes. The one or more media item attributes may be indicative of whether a ranking of the media item is to be adjusted.

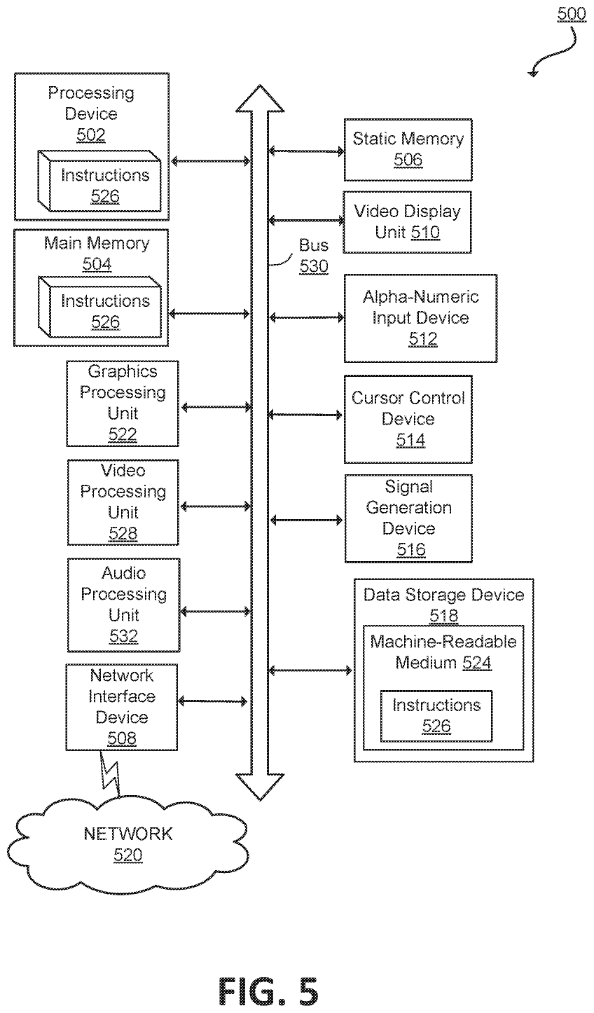

FIG. 5 illustrates an example machine of a computer system 500 within which a set of instructions, for causing the machine to perform any one or more of the methodologies discussed herein, may be executed. The computer system 500 can be the sever machine 150 or client devices 102A-N of FIG. 1. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM), a static memory 506 (e.g., flash memory, static random access memory (SRAM), etc.), and a data storage device 518, which communicate with each other via a bus 530.

Processing device 502 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 may be configured to execute instructions 526 for performing the operations and steps described herein.

The computer system 500 may further include a network interface device 508 to communicate over the network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), a graphics processing unit 522, a signal generation device 516 (e.g., a speaker), graphics processing unit 522, video processing unit 528, and audio processing unit 532.

The data storage device 518 may include a machine-readable storage medium 524 (also known as a non-transitory computer readable storage medium) on which is stored one or more sets of instructions 526 or software embodying any one or more of the methodologies or functions described herein. The instructions 526 may also reside, completely or at least partially, within the main memory 504 and/or within the processing device 502 during execution thereof by the computer system 500, the main memory 504 and the processing device 502 also constituting machine-readable storage media.

In some implementations, the instructions 526 include instructions to implement functionality corresponding to the present disclosure. While the machine-readable storage medium 524 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine, allowing the machine and the processing device 502 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform a similar sequence of procedures. In addition, the present disclosure is not described with reference to any particular programming language and any one in use in such computer systems may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element may be depicted in the figures and like elements are labeled with like numerals. The disclosure and drawings are, accordingly, to be regarded in an illustrative sense rather than a restrictive sense.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, engines, modules, and so on have been described with respect to interact between several components and/or blocks. It can be appreciated that such systems, engines, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

The methods and illustrative examples described herein are not inherently related to any particular computer or other apparatus. Various general purpose systems may be used in accordance with the teachings described herein, or it may prove convenient to construct more specialized apparatus to perform method 400 and/or each of its individual functions, routines, subroutines, or operations. Examples of the structure for a variety of these systems are set forth in the description above. The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
identifying a media item of a content sharing platform;
identifying a subset of comments of a plurality of comments in a comment section presented with the media item;
determining a comment score for each comment in the subset of comments, the comment score indicating comment attributes associated with a respective comment in the subset of comments;
determining at least one comment section score for the media item based on comment scores of the subset of comments;
determining one or more media item attributes of the media item based on the at least one comment section score; and
associating the media item with the one or more media item attributes, wherein the one or more media item attributes are indicative of whether a ranking of the media item is to be adjusted.

2. The method of claim 1 wherein determining the one or more media item attributes of the media item comprises determining whether the at least one comment section score satisfies one or more criteria corresponding to the one or more media item attributes.

3. The method of claim 1, wherein determining the at least one comment section score based on the comment scores comprises:
determining weights for the comment scores based on one or more factors;
applying the weights to the comment scores of the subset of comments; and
determining the comment section score based on an average of weighted comment scores of the subset of comments.

4. The method of claim 3, wherein the one or more factors comprise a ratio of a number of impressions a respective comment in the subset of comments received within a time period compared to a total number of impressions the subset of comments received within the time period.

5. The method of claim 3, wherein the one or more factors comprise a ratio of a number of likes a respective comment in the subset of comments received within a time period compared to a total number of likes the subset of comments received within the time period.

6. The method of claim 3, wherein each comment has a plurality of comment scores pertaining to different comment score types, and wherein each of the at least one comment section score is determined based on comment scores of a same comment score type.

7. The method of claim 1, wherein the one or more media item attributes for the media item comprise at least one of a user level engagement attribute, a comment section satisfaction attribute, a comment section sentiment attribute, a comment section emotion attribute, a comment section content quality attribute, a comment section subscriber engagement attribute, or a comment section creator engagement attribute.

8. The method of claim 1, wherein the subset of comments is identified based on at least one of a number of likes of each of the plurality of comments within a first time period or a number of impressions each of the plurality of comments received within a second time period.

9. A system comprising:
a memory device; and
a processing device coupled to the memory device to perform operations comprising:
identifying a media item of a content sharing platform;
identifying a subset of comments of a plurality of comments in a comment section presented with the media item;
determining a comment score for each comment in the subset of comments, the comment score indicating comment attributes associated with a respective comment in the subset of comments;
determining at least one comment section score for the media item based on comment scores of the subset of comments;
determining one or more media item attributes of the media item based on the at least one comment section score; and
associating the media item with the one or more media item attributes, wherein the one or more media item attributes are indicative of whether a ranking of the media item is to be adjusted.

10. The system of claim 9, wherein determining the one or more media item attributes of the media item comprises determining whether the comment section score satisfies one or more criteria corresponding to the one or more media item attributes.

11. The system of claim 9, wherein determining the at least one comment section score based on the comment scores comprises:
determining weights for the comment scores based on one or more factors;
applying the weights to the comment scores of the subset of comments; and
determining the comment section score based on an average of weighted comment scores of the subset of comments.

12. The system of claim 11, wherein the one or more factors comprise a ratio of a number of impressions a respective comment in the subset of comments received within a time period compared to a total number of impressions the subset of comments received within the time period.

13. The system of claim 11, wherein each comment has a plurality of comment scores of different comment score types, and wherein each of the at least one comment section score is determined based on comment scores of a same comment score type.

14. The system of claim 9, wherein the one or more media item attributes for the media item comprise at least one of a user level engagement attribute, a comment section satisfaction attribute, a comment section sentiment attribute, a comment section emotion attribute, a comment section content quality attribute, a comment section subscriber engagement attribute, or a comment section creator engagement attribute.

15. The system of claim 9, wherein the subset of comments is identified based on at least one of a number of likes of each of the plurality of comments within a first time period or a number of impressions each of the plurality of comments received within a second time period.

16. A non-transitory computer readable storage medium comprising instructions for a server that, when executed by a processing device, cause the processing device to perform operations comprising:
identifying a media item of a content sharing platform;
identifying a subset of comments of a plurality of comments in a comment section presented with the media item;
determining a comment score for each comment in the subset of comments, the comment score indicating comment attributes associated with a respective comment in the subset of comments;
determining at least one comment section score for the media item based on comment scores of the subset of comments;
determining one or more media item attributes of the media item based on the at least one comment section score; and
associating the media item with the one or more media item attributes, wherein the one or more media item attributes are indicative of whether a ranking of the media item is to be adjusted.

17. The non-transitory computer readable storage medium of claim 16 wherein determining the one or more media item attributes of the media item comprises determining whether the at least one comment section score satisfies one or more criteria corresponding to the one or more media item attributes.

18. The non-transitory computer readable storage medium of claim 16, wherein determining the at least one comment section score based on the comment scores comprises:
determining weights for the comment scores based on one or more factors;
applying the weights to the comment scores of the subset of comments; and
determining the comment section score based on an average of weighted comment scores of the subset of comments.

19. The non-transitory computer readable storage medium of claim 18, wherein each comment has a plurality of comment scores of different comment score types, and wherein each of the at least one comment section score is determined based on comment scores of a same comment score type.

20. The non-transitory computer readable storage medium of claim 16, wherein the one or more media item attributes for the media item comprise at least one of a user level engagement attribute, a comment section satisfaction attribute, a comment section sentiment attribute, a comment section emotion attribute, a comment section content quality attribute, a comment section subscriber engagement attribute, or a comment section creator engagement attribute.
